(19) United States
(12) Patent Application Publication
(10) Pub. No.: US 2025/0292361 A1
(43) Pub. Date: Sep. 18, 2025

(54) IMAGE STITCHING METHOD AND APPARATUS AND NON-TRANSITORY COMPUTER-READABLE MEDIUM

(71) Applicants: Tianhao FA, Beijing (CN); Ying Zhao, Beijing (CN)

(72) Inventors: Tianhao FA, Beijing (CN); Ying Zhao, Beijing (CN)

(73) Assignee: Ricoh Company, Ltd., Tokyo (JP)

(21) Appl. No.: 19/073,461

(22) Filed: Mar. 7, 2025

(30) Foreign Application Priority Data
Mar. 15, 2024 (CN) 202410297558.4

(51) Int. Cl. G06T 3/4038; G06T 7/00; G06T 7/33

(52) U.S. Cl. CPC G06T 3/4038; G06T 7/0002; G06T 7/337; G06T 2207/20221; G06T 2207/30168

(57) ABSTRACT

An image stitching method includes obtaining images arranged in an array; acquiring, in a pair-by-pair stitching process performed on the images by rows along a first direction, a first stitching homography matrix corresponding to each image pair, wherein, the stitching result of the same image pair is evaluated based on the first stitching homography matrix corresponding to the same image pair, and if the stitching result does not meet a predetermined condition, the same image pair is stitched by utilizing the first stitching homography matrix corresponding to the image pair of the same column in a previously-stitched row, or a first initial homography matrix corresponding to the column, where the same image pair is located, is acquired and utilized to stitch the same image pair; and if the images contain multiple rows, further stitching the images by columns along a second direction to generate a stitched image.

### CROSS-REFERENCE TO RELATED APPLICATIONS

The present application is based on and claims the benefit of priority of Chinese Patent Application No. 202410297558.4 filed on Mar. 15, 2024, the entire contents of which are hereby incorporated by reference.

### BACKGROUND OF THE DISCLOSURE

### 1. Field of the Disclosure

The present disclosure relates to the technical field of image processing, and specifically, an image stitching method and apparatus as well as a non-transitory computer-readable medium.

### 2. Description of the Related Art

In the process of stitching images by way of a deep neural network, it is usually necessary to first extract the features of the images to be stitched; match the features of all the adjacent images to calculate homography matrices that are used to deform the images; and deform the images in accordance with the homography matrices and fuse the images to finally obtain a stitched image.

However, in the existing image stitching methods, due to various reasons such as the shooting angle of a camera, the ratio of near view to distant view of images, a large similarity between the images, and the like, it is often easy to cause false matching of image feature points, so that the results of image deformation and fusion do not meet expectations, and image stitching fails. In addition, during the image stitching process, it is impossible to provide a prejudgment and correction approach for the image stitching result, thereby resulting in not being able to modify and adjust an image stitching mistake problem.

As such, a more robust image stitching method is needed, that can timely correct an error occurred in an image stitching process and adjust the relating homography matrix, so as to reduce the image stitching error and improve the image stitching quality.

### SUMMARY OF THE DISCLOSURE

The present disclosure aims to provide a method and apparatus for stitching images, by which it is possible to solve the above-described technical problems.

According to a first aspect of the present disclosure, an image stitching method is provided that includes steps of obtaining a plurality of images arranged in an array, wherein, the array of the plurality of images contains a plurality of image columns along a first direction and at least one image row along a second direction different from the first direction, and there is at least a predetermined range of overlap greater than zero between the adjacent images respectively arranged along the first direction and the second direction; acquiring, in an image pair-by-image pair stitching process performed on the plurality of images by image rows along the first direction, a first stitching homography matrix corresponding to each of image pairs formed by the adjacent images, wherein, a stitching result of the same image pair is evaluated based on the first stitching homography matrix corresponding to the same image pair, and in response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is acquired and utilized to stitch the same image pair; and further stitching, in response to the plurality of images being inclusive of a plurality of image rows, the plurality of images by image columns along the second direction so as to generate a stitched image.

According to a second aspect of the present disclosure, an image stitching apparatus is provided that includes an obtainment part configured to obtain a plurality of images arranged in an array, wherein, the array of the plurality of images contains a plurality of image columns along a first direction and at least one image row along a second direction different from the first direction, and there is at least a predetermined range of overlap greater than zero between the adjacent images respectively arranged along the first direction and the second direction; and a stitching part configured to acquire, in an image pair-by-image pair stitching process performed on the plurality of images by image rows along the first direction, a first stitching homography matrix corresponding to each of image pairs formed by the adjacent images, wherein, a stitching result of the same image pair is evaluated based on the first stitching homography matrix corresponding to the same image pair, and in response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is acquired and utilized to stitch the same image pair, and further stitch, in response to the plurality of images being inclusive of a plurality of image rows, the plurality of images by image columns along the second directions so as to generate a stitched image.

According to a third aspect of the present disclosure, another image stitching apparatus is provided that includes a processor and a storage storing a computer program, coupled to the processor. Here, the computer program causes, when executed by the processor, the processor to implement the image stitching method according to the first aspect of the present disclosure.

According to a fourth aspect of the present disclosure, a non-transitory computer-readable storage medium including a computer program for execution by a processor (in a computer, for example) is provided. Here, the computer program causes, when executed by the processor, the processor to implement the image stitching method according to the first aspect of the present disclosure.

On the basis of the image stitching method and apparatuses as well as the non-transitory computer-readable storage medium according to the aspects of the present disclosure, during an image stitching process, it is possible to select an appropriate homography matrix for conducting image stitching by timely evaluating the stitching result and adaptively adjusting the related homography matrix, thereby being capable of reducing the image stitching error and improving the image stitching quality.

### BRIEF DESCRIPTION OF THE DRAWINGS

FIG. 1 illustrates two images (a) and (b) of a shelf having a predetermined range of overlap captured by a camera;

FIG. 2 shows an erroneously stitched image caused by false matching of feature points after stitching the two images (a) and (b) in FIG. 1;

FIG. 3 represents a correctly stitched image obtained by stitching the two images (a) and (b) in FIG. 1;

FIG. 4 is a flowchart of an image stitching method in accordance with an embodiment of the present disclosure;

FIG. 5 illustrates an example of an image pair-by-image pair stitching process by image rows along a first direction in accordance with the embodiment of the present disclosure;

FIG. 6 represents an exemplary camera array in accordance with the embodiment of the present disclosure;

FIG. 7 shows a plurality of images arranged in an M*N array obtained exemplarily in accordance with the embodiment of the present disclosure;

FIG. 8 illustrates exemplary row-stitched images obtained after performing image stitching by image rows in accordance with the embodiment of the present disclosure;

FIG. 9 represents an example of an image stitching process by image columns in accordance with the embodiment of the present disclosure;

FIG. 10 shows an example of a stitched image in accordance with the embodiment of the present disclosure;

FIG. 11 is a block diagram of an image stitching apparatus in accordance with another embodiment of the present disclosure; and

FIG. 12 is a block diagram of an image stitching apparatus in accordance with still another embodiment of the present disclosure.

### DETAILED DESCRIPTION OF THE PREFERRED EMBODIMENTS

In order to let a person skilled in the art better understand the present disclosure, hereinafter, the embodiments of the present disclosure are concretely described with reference to the drawings. However, it should be noted that the same symbols, that are in the specification and the drawings, stand for constituent elements having basically the same function and structure, and the repetition of the explanations to the constituent elements is omitted.

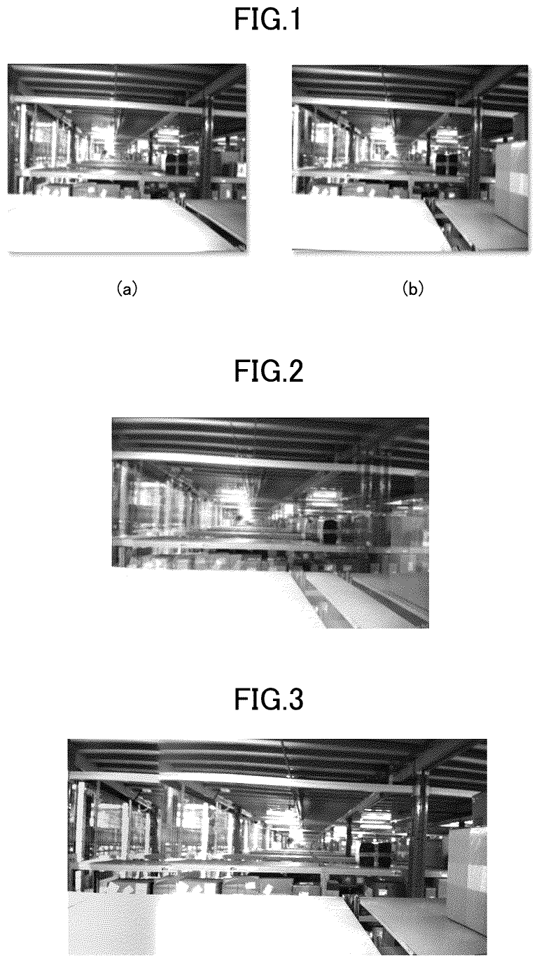

In various application scenarios such as warehouses, stores, shelf management, and so on, it is often necessary to obtain a stitched image by stitching images taken by a camera. However, false matching of feature points may occur due to various reasons such as the shooting angle of the camera, the ratio of near view to distant view of the images, a large similarity between the images, the lack of significant features, and the like, so that the results of image deformation and fusion do not meet expectations, and image stitching fails. FIG. 1 illustrates two images (a) and (b) of a shelf with a predetermined range of overlap captured by a camera. FIG. 2 shows an erroneously stitched image caused by false matching of feature points after stitching the two images (a) and (b) in FIG. 1 by utilizing a conventional image stitching method. According to FIG. 2, it can be seen that the similarity between the two images (a) and (b) in FIG. 1 is relatively large, that affects the image stitching result, resulting in the inability to correctly match the feature points so as to obtain a correct shelf image.

As such, there is a need to provide an image stitching method and apparatus as well as a non-transitory computer-readable medium by which it is possible to timely correct an error generated in an image stitching process so as to obtain a correctly stitched image. On the basis of the image stitching method in accordance with an embodiments of the present disclosure, as shown in FIG. 3, a correctly stitched image can be generated by performing image stitching on the two images (a) and (b) in FIG. 1.

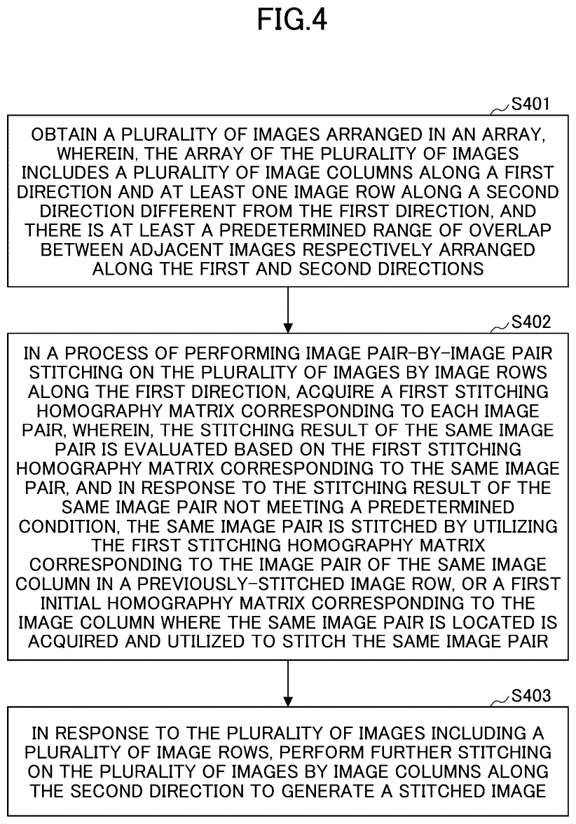

FIG. 4 is a flowchart of an image stitching method in accordance with an embodiment of the present disclosure. As represented in FIG. 4, the image stitching method includes STEPS S401 to S403. In what follows, the image stitching method is minutely described by referring to FIG. 4.

STEP S401 in FIG. 4 is obtaining a plurality of images arranged in an array. In the array of the plurality of images, a plurality of image columns (also called columns for short) are arranged along a first direction, and at least one image row (also called a row for short) is arranged along a second direction different from the first direction. Moreover, there exists at least a predetermined range of overlap greater than zero between any two adjacent images respectively arranged in the first direction and the second directions.

According to this embodiment, the plurality of images arranged in an array have a plurality of image columns (e.g., M image columns) and one or more image rows (e.g., N image rows). Here, the image columns of the plurality of images are arranged along a first direction, and the one or more image rows of the plurality of images are arranged along a second direction. The first direction is different from the second direction. Optionally, the first direction is perpendicular to the second direction. In addition, optionally, the first direction may also have a specific angle with respect to the second direction. The specific angle may be, for example, 30 degrees, 45 degrees, 60 degrees, or 80 degrees. However, it should be noted that the present disclosure is not limited to these kinds of angles.

Furthermore, according to this embodiment, it is possible to capture the plurality of images arranged in an M*N array (having M columns and N rows) by means of one or more cameras. In an example, one camera is utilized to capture the plurality of images arranged in the M*N array by acquiring M images for each image row. In another example, N cameras are utilized to capture the plurality of images arranged in the M*N array by acquiring N images of M columns one time. Of course, in still another example, one camera may also be utilized to capture the plurality of images arranged in the M*N array through various means such as acquiring images by zigzag reciprocating motion, acquiring images by vortex motion, and the like. Alternatively, in yet another example, N/b cameras may be utilized to capture the plurality of images arranged in the M*N array by repeatedly acquiring N/b images of M columns b times; here, b is a parameter whose value may be 2, 3, and so on. However, it should be noted that these types of approaches of capturing the plurality of images arranged in the M*N array are only examples. In the practical applications, different image capture approaches may be adopted on the basis of different application scenarios, camera parameter settings, image sizes, etc. to adapt to the needs of the follow-on image stitching. Here, there is not any limitation.

In this embodiment, among the captured plurality of images arranged in the M*N array, any two adjacent images along the first direction and the second direction have at least a predetermined range of overlap. Optionally, the predetermined range of overlap is 40%. In addition, optionally, the predetermined ranges of overlap may also be a different value such as 45%, 50%, or the like. Furthermore, the predetermined ranges of overlap between the adjacent images along the first direction and the second direction may be different or the same. For example, in the first direction, the predetermined range of overlap is 45%; whereas, in the second direction, the predetermined range of overlap is 55%. However, it should be noted that these kinds of limitations to the predetermined ranges of overlap between the adjacent images along the first direction and the second direction are just examples. In the practical applications, specific settings can be made according to different application scenarios and image capture requirements. Here, there is not any limitation.

STEP S402 of FIG. 4 is obtaining, in the process of performing image pair-by-image pair (also called pair-by-pair for short) stitching on the plurality of images by image rows along the first direction, a first stitching homography matrix corresponding to each of image pairs formed by the adjacent images. Here, the stitching result of each image pair is evaluated on the basis of the first stitching homography matrix corresponding to the same image pair. In response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is obtained and utilized to stitch the same image pair.

In this embodiment, with respect to the plurality of images arranged in the M*N array, it is possible to perform image pair-by-image pair stitching on each of the N image rows. Specifically, for each image row of the plurality of images, it is possible to calculate, according to the M−1 image pairs formed by all the two adjacent images, a first stitching homography matrix for stitching corresponding to each of the M−1 image pairs, and perform the image pair-by-image pair stitching on the basis of the first stitching homography matrices. That is, for each image row of the plurality of images, first, the image pair consisting of the first image and the second image in the same image row is stitched, i.e., by calculating the first stitching homography matrix of the image pair, the second image is deformed for the fusion of the first image and the second image; then, the image pair consisting of the second image and the third image in the same image row is stitched in the same way; and so on, until the calculation of the first stitching homography matrices of all the M−1 image pairs in the same image row is completed. Optionally, in the process of calculating the first stitching homography matrices, a neural network can be adopted to calculate the first stitching homography matrices by utilizing a deep learning approach.

In this embodiment, during the process of stitching each image pair, it is possible to evaluate the stitching result of the same image pair on the basis of the first stitching homography matrix corresponding to the same image pair. Here, if the evaluated stitching result of the same image pair meets the predetermined condition, then it is determined that the calculated first stitching result is applied on the same image pair. If the evaluated stitching result of the same image pair does not meet the predetermined condition, then the calculated first stitching homography matrix is not adopted, and the first stitching homography matrix corresponding to the image pair of the same image column in a previously-stitched image row is selected to stitch the same image pair, or a first initial homography matrix corresponding to the image column, where the same image pair is located, is obtained and utilized to stitch the same image pair.

In this embodiment, after obtaining the plurality of images arranged in the M*N array, in STEP S402 of FIG. 4, it is possible to obtain, when necessary, a first initial homography matrix required for stitching corresponding to each image pair in each image row.

As an option, it is possible to determine, for each of the M−1 image pairs formed by all the two adjacent images of the M image columns in each of the N image rows, the corresponding first initial homography matrix required for stitching. That is, for each image row, a first initial homography matrix is determined with respect to the image pair consisting of the first image and the second image in the same image row; a first initial homography matrix is determined with respect to the image pair consisting of the second image and the third image in the same image row; and so on. As such, a total of M−1 first initial homography matrices can be generated for the M−1 image pairs formed in each of the N image rows. Generally speaking, in a camera array, the relative distances between the cameras located in the same column are fixed, so the image pairs corresponding to the same image column can share the same first initial homography matrix. In other words, it is possible to determine the M−1 first initial homography matrices only for the M−1 image pairs in a predetermined image row, and each image pair in each of the other image rows can share the first initial homography matrix corresponding to the image column where the same image pair is located, among the M−1 first initial homography matrices determined only for the M−1 image pairs in the predetermined image row.

When determining these first initial homography matrices, optionally, only the change in the displacement between the two adjacent images in each image pair may be considered, without considering the other relationships between the two adjacent images. Therefore, in an example, it is possible to obtain, based on the relative displacement between the images in each image pair of one image row, the corresponding first initial homography matrix representing the relative displacement. In another example, a neural network is utilized to calculate the corresponding first initial homography matrix representing the relative displacement. Of course, these kinds of approaches of determining the first initial homography matrices are only examples. It is also possible to determine the first initial homography matrices in different ways according to the practical applications. There are no restrictions here. Additionally, the obtainment time of the first initial homography matrices may be before the acquisition of the image pairs or the evaluated results for performing the image pair-by-image pair stitching by image rows, or after the acquisition of the image pairs or the evaluated results. There are no restrictions here. Furthermore, if the first stitching homography matrix based stitching approach can be applied to each image pair when conducting the stitching by image rows, then it is not necessary to obtain the corresponding first initial homography matrix, i.e., it is possible to directly make use of the corresponding first stitching homography matrix to accomplish the corresponding stitching.

In the process of obtaining, based on the relative displacement between the images in each image pair of one image row, the corresponding first initial homography matrix representing the relative displacement, the following various exemplary approaches may be adopted to calculate the relative displacement and/or determine the corresponding first initial homography matrix.

In a first exemplary approach, it is possible to determine, based on the movement distance of the camera capturing the images of each image pair in one image row, the relative displacement between the images in the same image pair. For example, if it is known that a device equipped with a camera is used for controlling the movement of the camera and moves 30 centimeters along a first direction during the process of capturing two images forming an image pair, then it can be determined that the camera also moves 30 centimeters along the first direction accordingly. On the basis of this, it is possible to determine that the relative displacement between the two images in the image pair is 30 centimeters. Additionally, if the relative displacement between the two images in the image pair needs to be determined in units of pixels, etc., then the correspondence between the movement distance of the camera and the relative displacement of the two images in the image pair expressed in units of pixels, etc. can be set in advance, thereby converting the movement distance of the camera into a relative displacement in units of pixels, etc. For example, it can be assumed that if a camera moves 10 centimeters along a first direction one time, then the captured images forming an image pair relatively move 1000 pixels. On the basis of this, if the camera moves 50 centimeters in the first direction during the process of capturing the image pair, then the relative displacement between the images of the image pair can be calculated as 1000*50/10=5000 pixels. Finally, it is possible to obtain, based on the relative displacement between the images of each image pair in one image row, a first initial homography matrix corresponding to the same image pair.

In a second exemplary approach, as a special case of the first exemplary approach, if the movement distance of the device equipped with the camera for controlling the movement of the camera is always a fixed value during the process of capturing two images forming each image pair in one or more image rows, then it is possible to first obtain the first initial homography matrix corresponding to a predetermined image pair and apply this first initial homography matrix to all the image pairs in the one or more image rows. That is, when conducting image stitching along the first direction, only one first initial homography matrix is utilized for the plurality of image pairs in the one or more image rows. Here, the predetermined image pair mentioned above may be the first image pair in an image row or the middle image pair therein; in other words, the predetermined image pair may be selected and set arbitrarily without any limitation.

In a third exemplary approach, it is also possible to determine, based on the range of overlap between the pixels of an image in an image pair and the pixels of another image adjacent to the image in the image pair, the relative displacement of the two images. For example, if an image in an image pair includes 5000 pixels along a first direction, and the range of overlap between the pixels of the image and the pixels of another image in the image pair is 40%, then the relative displacement of the two images in the image pair is calculated as 5000*(1−40%)=3000 pixels. On the basis of this, a first initial homography matrix corresponding to the image pair can be obtained.

In a fourth exemplary approach, the first initial homography matrix used when performing stitching to an image pair that has been stitched as a whole may be applied to the stitching of the other image pairs. For example, in the process of completing stitching of shelf images, if the image collection manner for each shelf is the same, e.g., when collecting the shelf images, the related camera captures a plurality of images, each of which is arranged in an M*N array, with respect to each shelf for stitching, and the result after accomplishing image stitching of a shelf is satisfactory, then it is possible to apply the first initial homography matrix used when stitching the images of the shelf to the stitching process of all the subsequent shelf images.

Of course, in the above-described exemplary approaches, the various parameters adopted may be preset or automatically acquired. For example, the movement distance of the device controlling the movement of a camera when the camera captures the adjacent images may be set by manual input in advance, or may be automatically acquired from the device controlling the movement of the camera via a wired or wireless network.

Optionally, the evaluation with respect to the stitching result of an image pair may adopt various approaches. For example, the evaluation with respect to the stitching result can be conducted according to a transformed image or a fused image obtained on the basis of the image pair and its first stitching homography matrix. Here, the transformed image may be obtained by transforming one of the two images in the image pair using the corresponding first stitching homography matrix, and the fused image may be obtained by fusing the two images in the image pair using the corresponding first stitching homography matrix. After obtaining the transformed image and/or the fused image, the evaluation of the stitching result can be conducted with respect to the transformed image and/or the fused image by utilizing the result of at least one of target detection, feature extraction, shape detection, a structural similarity, and a peak signal-to-noise ratio, thereby determining whether the stitching result meets the predetermined condition.

As an option, when performing evaluation on the transformed image and/or the fused image using the target detection or the feature extraction, it is possible to determine whether the stitching result meets the predetermined condition by means of, for example, the detection result of a predetermined pattern, target or feature acquired using a pre-trained neural network according to a specific application scenario of this embodiment. When performing evaluation on the transformed image and/or the fused image using the shape detection, it is possible to determine whether the shape of the transformed image and/or the shape of the fused image meet/meets an expected image shape (such as a rectangle, a square, a parallelogram, etc.) to determine whether the stitching result meets the predetermined condition. When performing evaluation on the transformed image and/or the fused image using the structural similarity and/or the peak signal-to-noise ratio, it is possible to determine whether the stitching result meets the predetermined condition by way of the parameter regarding the structural similarity and/or the parameter regarding the peak signal-to-noise ratio of the transformed image and/or the fused image. Furthermore, in other embodiments of the present disclosure, the stitching result may also be evaluated on the basis of various aspects such as the relative positions of the corner points of the transformed image and/or the fused image, the scanning direction of the camera, the image transformation and/or fusion quality, and the like. Here, it should be noted that the above-described various approaches of evaluating the stitching result are only examples. That is, different approaches may be adopted for evaluating the stitching result according to different practical application scenarios without any limitation.

In this embodiment, as described above, when the stitching result of an image pair (also called a current image pair) in an image row (also called a current image row) does not meet the predetermined condition, it is possible to select the first stitching homography matrix corresponding to the image pair of the same image column in a previously-stitched image row or the first initial homography matrix corresponding to the current image pair for stitching the current image pair. Optionally, when there are one or more previously-stitched image rows for the current image row, it is possible to first select the first stitching homography matrix corresponding to the image pair of the same image column in the previously-stitched image row (also called a first previous image row) closest to the current image row, and evaluate the stitching result of the current image pair in a similar manner as set forth above. If the evaluated stitching result of the current image pair meets the predetermined condition, then the current image pair can be stitched. At this time, when, after the evaluation, the stitching result of the current image pair obtained by utilizing the first stitching homography matrix corresponding to the image pair of the same image column in the first previous image row does not meet the predetermined condition, it is possible to sequentially select, by analogy, the first stitching homography matrix corresponding to the image pair of the same image column in the previously-stitched image row (also called a second previous image row) closest to the first previous image row, and evaluate the stitching result of the current image pair in a similar manner as described above. If the evaluated stitching result of the current image pair meets the predetermined condition, then the current image pair can be stitched. When the evaluated results based on the first stitching homography matrices corresponding to all the previously-stitched image rows do not meet the predetermined condition, it is possible to select the first initial homography matrix corresponding to the current image pair to stitch the current image pair. In other words, if the plurality of images form only one image row, or there does not exist a previously-stitched image row for the current image row, then the first initial homography matrix corresponding to the current image pair can be selected to stitch the current image pair.

In an example, regarding the plurality of images arranged in the M*N array, when performing stitching on the first image row of the N image rows, e.g., the image pair consisting of the first image and the second image in the first image row, it is possible to first calculate the first stitching homography matrix of the image pair, and evaluate the transformed image and/or the fused image obtained by utilizing the first stitching homography matrix. At this time, when the stitching result of the image pair does not meet the predetermined condition, because there does not exist a previously-stitched image row for the first image row, the first initial homography matrix corresponding to the image pair can be adopted to stitch the image pair. After that, the stitching of all the image pairs in the first image row can be completed by analogy.

After performing the stitching on the first image row, it is possible to continue to conduct stitching with respect to the second image row of the N image rows. When stitching the image pair consisting of the first image and the second image in the second image row, it is also necessary to first calculate the corresponding first stitching homography matrix. If the stitching result of the image pair evaluated in a similar manner as described above does not meet the predetermined conditions, then the first stitching homography matrix corresponding to the same image column of the first image row, that is closest to the second image row and has been stitched, can be selected and applied first, and the related evaluation is continued. If the evaluated stitching result of the image pair still does not meet the predetermined condition, then the first initial homography matrix corresponding to the same image column of the second image row can be adopted for stitching the image pair because there are no more previously-stitched image rows. After that, the stitching of the second image row can be completed by analogy.

Subsequently, the image pairs in the remaining image rows of the N rows is stitched in a similar manner, so that a row-stitched image corresponding to each of the N rows is generated.

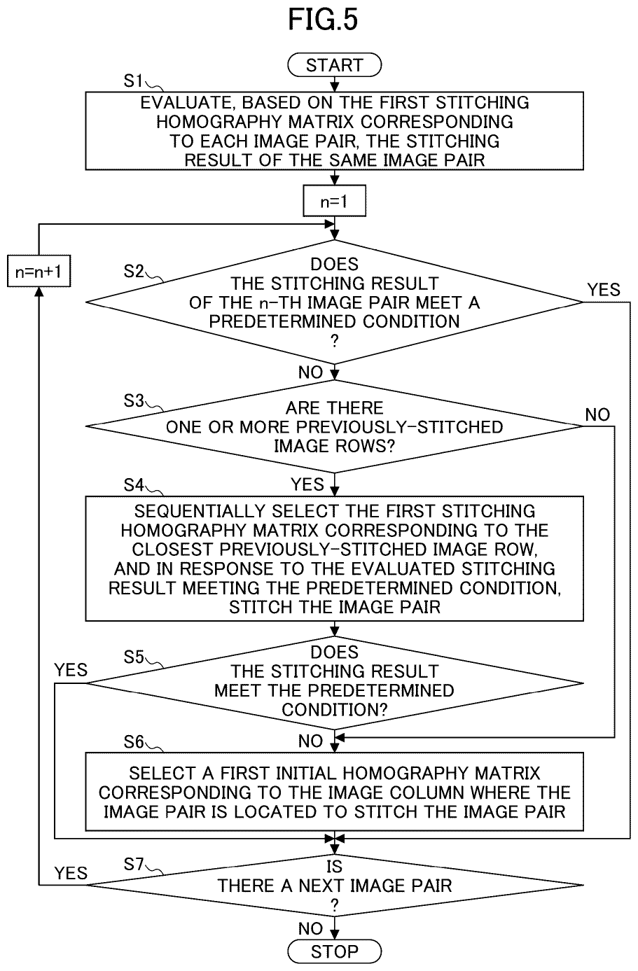

FIG. 5 illustrates an example of an image pair-by-image pair stitching process by image rows along a first direction in accordance with this embodiment. As shown in FIG. 5, the image pair-by-image pair stitching process is inclusive of STEPS S1 to S7. When performing stitching on a plurality of images arranged in an M*N array, in STEP S1, first, a first stitching homography matrix corresponding to a certain image pair (also called a current image pair) in a certain image row (also called a current image row) is calculated, and then, evaluation is conducted with respect to the stitching result such as the transformed image and/or the fused image obtained by utilizing the first stitching homography matrix.

When the current image pair in the current image row in STEP S1 is a first image pair, i.e., n=1, in STEP S2, whether the stitching result of the n-th image pair meets a predetermined condition is evaluated. At this time, if the evaluated result of STEP S2 is yes, i.e., the stitching result meets the predetermined condition, then the image pair-by-image pair stitching process enters STEP S7. In STEP S7, it is determined whether there exists a next image pair, i.e., whether there exists a n+1-th image pair. If the determined result of STEP S7 is yes, then n+1 is assigned to n, i.e., n=n+1, and STEP S2 is executed again; otherwise, the image pair-by-image pair stitching process stops.

If the evaluated result of STEP S2 is no, i.e., the stitching result does not meet the predetermined condition, then the image pair-by-image pair stitching process enters STEP S3. In STEP S3, it is determined whether there exist one or more image rows (also called previously-stitched image rows) in which the image pairs were stitched previously. If the determined result of STEP S3 is no, i.e., there do not exist one or more previously-stitched image rows, then the image pair-by-image pair stitching process enters STEP S6. In STEP S6, a first initial homography matrix corresponding to the image column, where the n-th image pair is located, is selected, and the n-th image pair is stitched by utilizing the selected first initial homography matrix.

If the determined result of STEP S3 is yes, i.e., there exist one or more previously-stitched image rows, then the image pair-by-image pair stitching process enters STEP S4. In STEP S4, the first stitching homography matrix corresponding to the previously-stitched image row closed to the current image row is sequentially selected (for example, the first stitching homography matrix corresponding to the n−1-th image row, in which the image pairs were stitched previously, is selected first; if the stitching result obtained by utilizing the selected first stitching homography matrix corresponding to the n−1-th image row is evaluated as not meeting the predetermined condition, then the n−2-th image row, in which the image pairs were stitched previously, is selected; and so on), and the n-th image pair is stitched when the stitching result obtained by utilizing the selected first stitching homography matrix is evaluated as meeting the predetermined condition.

After STEP S4 is completed, the image pair-by-image pair stitching process enters STEP S5. In STEP S5, it is determined whether the stitching result at this time meets the predetermined condition. If the determined result in STEP S5 is yes, then the image pair-by-image pair stitching process directly enters STEP S7. In STEP S7, it is determined whether there exists a next image pair, i.e., whether there is a n+1-th image pair. If the determined result in STEP S7 is yes, then n+1 is assigned to n, i.e., n=n+1, and STEP S2 is executed again; otherwise, the image pair-by-image pair stitching process stops.

If the determined result in STEP S5 is no, i.e., the evaluated result based on the first stitching homography matrix corresponding to each previously-stitched image row does not meet the predetermined condition, then the image pair-by-image pair stitching process enters STEP S6. In STEP S6, the first initial homography matrix corresponding to the image column, where the current image pair is located, is selected, and the current image pair is stitched by utilizing the selected first initial homography matrix.

After the stitching of all the image pairs in the current image row is completed, it is possible to continue to complete stitching of the image pairs of the remaining image rows in a similar manner, so as to generate a row-stitched image corresponding to each image row in the N image rows.

Referring to FIG. 4 again; in STEP S403, if the plurality of images contains a plurality of image rows, then the plurality of images are further stitched by image columns along the second direction, so that a fully-stitched image is generated.

In this embodiment, after the stitching by image rows for the plurality of images arranged in the M*N array is completed, stitching is further completed for each of the M image columns in the plurality of images in a manner similar to the stitching by image rows, so as to generate a complete stitched image.

Optionally, in the process of performing image pair-by-image pair stitching on the plurality of images by image columns along the second direction, it is possible to obtain a second stitching homography matrix corresponding to each image pair, and evaluate, based on the second stitching homography matrix corresponding to each image pair, the stitching result of the same image pair. If the stitching result of the same image pair does not meet a predetermined condition, then the second stitching homography matrix corresponding to the image pair of the same image row in a previously-stitched image column is utilized to stitch the same image pair, or a second initial homography matrix corresponding to the image row, where the same image pair is located, is obtained, and the obtained second initial homography matrix is utilized to stitch the same image pair.

Optionally, when there exist one or more previously-stitched image columns for the current image column where the same image pair is located, it is possible to first choose the second stitching homography matrix corresponding to the image pair of the same image row in the previously-stitched image column (also called a first previous image column) closest to the current image column to stitch the same image pair, and evaluate the stitching result in a similar manner as described above. If the evaluated stitching result meets the predetermined condition, then the same image pair can be stitched; otherwise, it is possible to choose the second stitching homography matrix corresponding to the image pair of the same image row in the previously-stitched image column (also called a second previous image column) closest to the first previous image column to stitch the same image pair, and evaluate the stitching result in a similar manner as described above. If the evaluated stitching result meets the predetermined condition, then the same image pair can be stitched. In this way, if the evaluated result based on the second stitching homography matrix corresponding to each previously-stitched image column does not meet the predetermined condition, then the second initial homography matrix corresponding to the same image pair can be chosen to stitch the same image pair. In other words, when there do not exist one or more previously-stitched image columns for the current image column where the same image pair is located, it is possible to choose the second initial homography matrix corresponding to the same image pair to stitch the same image pair.

After the stitching by columns is completed, a complete stitched image arranged in the M*N array is obtained on the basis of the plurality of images arranged in the M*N array, the row-stitched image corresponding to each of the N image rows, and the column-stitched image corresponding to each of the M image columns.

On the basis of the image stitching method in accordance with this embodiment, during an image stitching process, it is possible to select, by timely evaluating the stitching results and adaptively adjusting the related homography matrices, appropriate homography matrices to conduct image stitching, thereby being capable of reducing the image stitching error and improving the image stitching quality.

The following represents a specific implementation process of an image stitching method based on deep learning, according to an example of this embodiment.

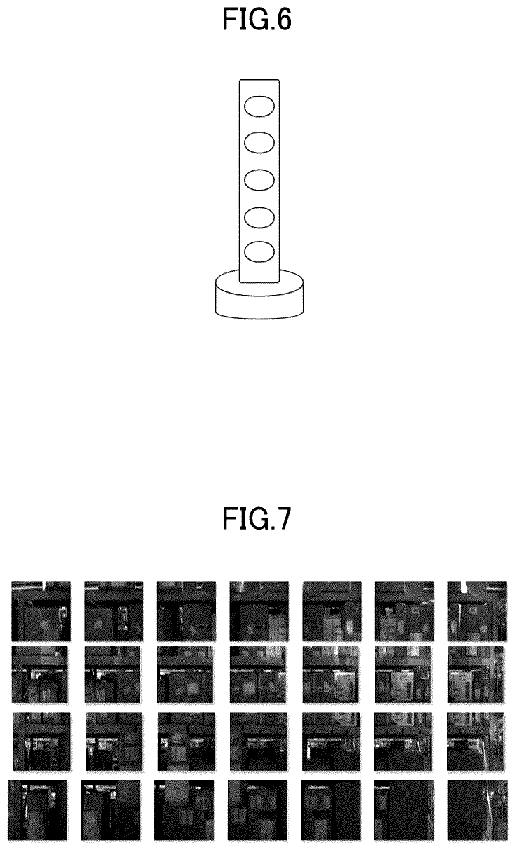

In this example, first, a camera array having N cameras is utilized to acquire a plurality of images arranged in an M*N array. FIG. 6 illustrates a camera array according to this example. FIG. 7 shows a plurality of images arranged in an M*N array acquired according to this example. As illustrated in FIG. 6, in this example, the camera array has four cameras arranged in a longitudinal direction (i.e., a second direction) for acquiring the plurality of images arranged in a 7*4 array as shown in FIG. 7 by conducting image collection multiple (seven) times in a transverse direction (i.e., a first direction). Here, the first direction and the second direction may be perpendicular to each other, and there may be at least 40% overlap between the adjacent images in the longitudinal direction and the transverse direction.

Next, a first initial homography matrix required for stitching corresponding to each image pair in each image row during the process of performing stitching by image rows on the plurality of images along the first direction is obtained.

In this example, after the plurality of images arranged in the 7*4 array are acquired, for the six image pairs formed by all the adjacent images of the seven image columns in each of the four image rows, a neural network is adopted to obtain, based on the relative displacement between the images in each of the six image pairs of the corresponding image row, six first initial homography matrices respectively representing the relative displacements.

Subsequently, image pair-by-image pair stitching is performed on the plurality of images, and a first stitching homography matrix corresponding to each image pair is obtained. Here, it is possible to conduct, for the plurality of images arranged in the 7*4 array, the stitching with respect to each of the four image rows. When performing the stitching on the first image row of the four image rows, e.g., the image pair formed by the first image and the second image in the first image row, it is possible to first utilize a neural network to calculate the first stitching homography matrix of the image pair, and evaluate the transformed image and/or the fused image obtained by utilizing the first stitching homography matrix. At this time, when the evaluated stitching result does not meet a predetermined condition, because there do not exist one or more previously-stitched image rows, it is possible to adopt the first initial homography matrix corresponding to the image pair to conduct the stitching with respect to the image pair. Then, and so on, the stitching of all the six image pairs in the first image row can be completed.

Afterwards, stitching is continued for the second image row of the four image rows. When stitching the image pair consisting of the first image and the second image in the second image row, it is also necessary to first calculate the corresponding first stitching homography matrix. If the stitching result evaluated in a manner similar to the above does not meet the predetermined condition, then the first stitching homography matrix corresponding to the same image column of the first image row that is closest to the second image row and was previously stitched is selected and applied first, and the related evaluation is continued. If the evaluated stitching result still does not meet the predetermined condition, then the first initial homography matrix corresponding to the same image column in the second image row is adopted for stitching the image pair. Then, and so on, the stitching of all the six image pairs in the second image row can be completed. Subsequently, stitching of the image pairs of the remaining image rows is continued in a similar manner, and a row-stitched image corresponding to each of the four image rows is be generated.

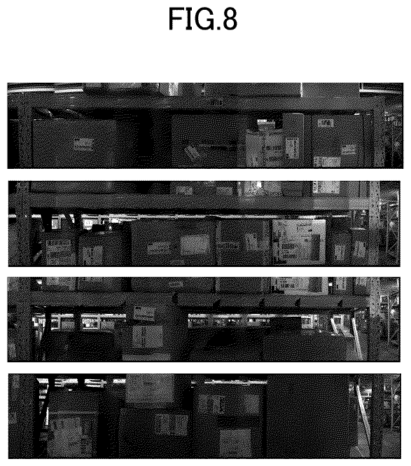

In this example, the stitching result of an image pair may be evaluated according to the transformed image and/or the fused image obtained by means of the image pair and the related first stitching homography matrix. Optionally, in this example, regarding the transformed image and/or the fused image, the result of determining the shape (such as whether it is still a rectangle), the peak signal-to-noise ratio PSNR, and/or the structural similarity SSIM may be respectively adopted to determine whether the stitching result meets the predetermined condition. FIG. 8 shows the row-stitched images generated after the stitching by image rows in accordance with this example. As shown in FIG. 8, it is possible to acquire the row-stitched image for each of the four cameras in this example.

Finally, the plurality of images are further stitched by columns along the second direction, so that a fully-stitched image is obtained. After the stitching by image rows is completed for the plurality of images arranged in the 7*4 array, stitching by image columns is further conducted with respect to the plurality of images arranged in the 7*4 array in a manner similar to the stitching by image rows, so as to eventually obtain a complete stitched image.

Optionally, it is possible to first utilize a neural network to obtain a second initial homography matrix required for stitching each image pair in a total of three image pairs of each image column in the plurality of images during the process of stitching the plurality of images by image columns along the second direction. Subsequently, image pair-by-image pair stitching is similarly performed on the plurality of images by image columns, and a second stitching homography matrix corresponding to each image pair is obtained by utilizing a neural network. Here, the stitching result of each of the image pairs is evaluated in the said manner according to the second stitching homography matrix corresponding to the same image pair. If the evaluated stitching result does not satisfy the predetermined condition, then the same image pair is stitched by way of the second stitching homography matrix corresponding to the image pair of the same image row in the previously-stitched image column or the second initial homography matrix corresponding to the same image row in the same image column.

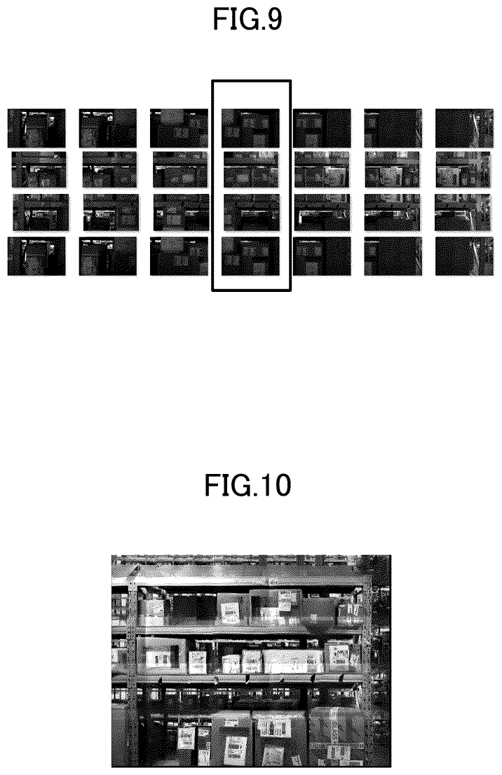

FIG. 9 represents an example of image stitching conducted by image columns in accordance with this embodiment. In this example, after obtaining each row-stitched image, the plurality of images initially captured in the 7*4 array and the row-stitched images are input, and the calculation regarding image stitching by columns is conducted. Specifically, for the three image pairs formed by all the adjacent images of the four images in each of the seven columns, on the basis of the relative displacement between the images in each of the three image pairs in the corresponding image column, three second initial homography matrices each of which represents the relative displacement are obtained.

Subsequently, image pair-by-image pair stitching is performed on the plurality of images by columns, and a second stitching homography matrix corresponding to each image pair is obtained. Here, it is possible to conduct, for the plurality of images arranged in the 7*4 array, the stitching with respect to each of the seven image columns. When performing the stitching on the first image column of the seven image columns, for example, the image pair formed by the first image and the second image in the first image column, it is possible to first calculate the second stitching homography matrix of the image pair, and evaluate the transformed image and/or the fused image obtained by utilizing the second stitching homography matrix. At this time, when the evaluated stitching result does not meet a predetermined condition, because there does not exist a previously-stitched image column, it is possible to adopt the second initial homography matrix corresponding to the image pair to conduct the stitching with respect to the image pair. Then, and so on, the stitching of all the three image pairs in the first image column can be completed.

Afterwards, stitching is continued for the second image column on the ride side of the first image column in the seven image column. When stitching the image pair consisting of the first image and the second image in the second image row, it is also necessary to first calculate the corresponding second stitching homography matrix. If the stitching result evaluated in a manner similar to the above does not meet the predetermined condition, then the second stitching homography matrix corresponding to the image pair of the same image row in the first image column that is closest to the second image column and was previously stitched is selected and applied first, and the related evaluation is continued. If the evaluated stitching result still does not meet the predetermined condition, then the second initial homography matrix corresponding to the same image row in the second image column is adopted for stitching the image pair. Then, and so on, the stitching of all the three image pairs in the second image column can be completed. Subsequently, stitching of the image pairs of the remaining image columns is continued in a similar manner, and a column-stitched image corresponding to each of the seven image columns is generated.

After the stitching conducted by image columns is completed, a complete stitched image arranged in the 7*4 array is obtained based on the plurality of images arranged in the 7*4 array, the row-stitched image corresponding to each of the four image rows, and the column-stitched image corresponding to each of the seven image columns.

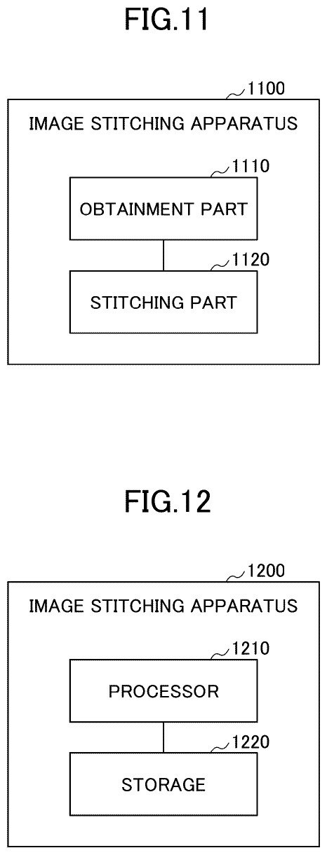

In what follows, an image stitching apparatus in accordance with an embodiment of the present disclosure is provided. FIG. 11 is a block diagram of an image stitching apparatus 1100 according to this embodiment. As illustrated in FIG. 11, the image stitching apparatus 1100 is inclusive of an obtainment part 1110 and a stitching part 1120. Of course, the image stitching apparatus 1100 may also include other parts as needed.

The image stitching apparatus 1100 is configured to carry out the image stitching method in accordance with the above embodiment. Particularly, the obtainment part 1110 is implemented to conduct STEP S401 in FIG. 4, and the stitching part 1120 is implemented to conduct STEPS S402 and S403 in FIG. 4. Here, it should be noted that for the reason that STEPS S401 to S403 of FIG. 4 have been minutely described in the above embodiment, the details of them are omitted in this embodiment.

On the basis of the image stitching apparatus in accordance with this embodiment, during an image stitching process, it is possible to select, by timely evaluating the stitching results and adaptively adjusting the related homography matrices, appropriate homography matrices to perform image stitching, so that the image stitching error can be reduced, and the image stitching quality can be improved.

Furthermore, another image stitching apparatus according to an embodiment of the preset disclosure is provided. FIG. 12 is a block diagram of an image stitching apparatus 1200 in accordance with this embodiment. As shown in FIG. 12, the image stitching apparatus 1200 includes a processor 1210 and a storage 1220 coupled to the processor 1210. Of course, the image stitching apparatus 1200 may also include other units as needed.

The processor 1210 is configured to execute a computer program (i.e., computer-executable instructions) stored in the storage 1220, so as to fulfill the image stitching method in accordance with the above embodiment. The processor 1210 may adopt any one of the conventional processors in the related art.

The storage 1220 is configured to store the computer program and the relating data as well as the intermediate results generated when the processor 1210 execute the computer program, for example. The storage 1220 may utilize any one of the existing storages in the related art.

In addition, a computer-executable program (i.e., a computer program) and a non-transitory computer-readable medium are provided according to an embodiment of the present disclosure. The computer-executable program may cause a computer to perform the image stitching method according to the above embodiment. The non-transitory computer-readable medium may store computer-executable instructions (i.e., the computer-executable program) for execution by a computer involving a processor(s). The computer-executable instructions may, when executed by the processor(s), cause the processor(s) to conduct the image stitching method in accordance with the above embodiment.

Here, it should be pointed out that the above embodiments are just exemplary ones, and the specific structure and operation of them are not be used for limiting the present disclosure.

In addition, the embodiments of the present disclosure may be implemented in any convenient form, for example, using dedicated hardware or a mixture of dedicated hardware and software. The embodiments of the present disclosure may be implemented as computer software executed by one or more networked processing apparatuses. The network may include any conventional terrestrial or wireless communications network, such as the Internet, and the like. The processing apparatuses may include any suitably programmed apparatuses such as a general-purpose computer, a personal digital assistant, a mobile telephone (such as a WAP or 3G, 4G, or 5G-compliant phone), and so on. Because the embodiments of the present disclosure may be implemented as software, each and every aspect of the present disclosure thus encompasses computer software implementable on a programmable device.

The computer software may be provided to the programmable device using any storage medium for storing processor-readable code such as a floppy disk, a hard disk, a CD ROM, a magnetic tape device, a solid state memory device, and so forth.

The related hardware platform may include any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present disclosure is described with reference to the specific embodiments chosen for purpose of illustration, it should be apparent that the present disclosure is not limited to these embodiments, but numerous modifications may be made thereto by a person skilled in the art without departing from the basic concept and technical scope of the present disclosure.

What is claimed is:

1. A method of stitching images, comprising:
obtaining a plurality of images arranged in an array, wherein, the array of the plurality of images contains a plurality of image columns along a first direction and at least one image row along a second direction different from the first direction, and there is at least a predetermined range of overlap greater than zero between the adjacent images respectively arranged along the first direction and the second direction;
acquiring, in an image pair-by-image pair stitching process performed on the plurality of images by image rows along the first direction, a first stitching homography matrix corresponding to each of image pairs formed by the adjacent images, wherein, a stitching result of the same image pair is evaluated based on the first stitching homography matrix corresponding to the same image pair, and in response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is acquired and utilized to stitch the same image pair; and
further stitching, in response to the plurality of images being inclusive of a plurality of image rows, the plurality of images by image columns along the second direction so as to generate a stitched image.

2. The method according to claim 1, wherein,
the obtainment of the plurality of images arranged in the array includes
obtaining the plurality of images by utilizing a camera or a camera group moving along the first direction, wherein, the camera group contains a plurality of cameras installed along the second direction.

3. The method according to claim 1, wherein,
the acquisition of the first initial homography matrix corresponding to the image column, where the same image pair is located, includes
acquiring, based on a relative displacement between the images in the same image pair, the first initial homography matrix corresponding to the image column where the same image pair is located, wherein, the first initial homography matrix represents the relative displacement.

4. The method according to claim 1, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of a plurality of image rows and there being one or more previously-stitched image rows, selecting the first stitching homography matrix corresponding to the image pair of the same image column in a first previously-stitched image row closest to the image row where the same image pair is located, further evaluating the stitching result of the same image pair, and stitching the same image pair in response to the evaluated stitching result meeting the predetermined condition,
in response to the further evaluated stitching result not meeting the predetermined condition, sequentially choosing the first stitching homography matrix corresponding to the image pair of the same image column in a second previously-stitched image row closest to the first previously-stitched image row, and stitching the same image pair in response to the evaluated stitching result meeting the predetermined condition, and
in response to the evaluated stitching results based on the first stitching homography matrices of all the previously-stitched image rows not meeting the predetermined condition, selecting the first initial homography matrix corresponding to the image column, where the same image pair is located, to stitch the same image pair.

5. The method according to claim 1, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of one image row or there not being one or more previously-stitched image rows, selecting the first initial homography matrix corresponding to the image column, where the same image pair is located, to stitch the same image pair.

6. The method according to claim 1, wherein,
the evaluation of the stitching result of the same image pair based on the first stitching homography matrix corresponding to the same image pair includes
performing, based on the first stitching homography matrix corresponding to the same image pair, transform on an image in the same image pair to acquire a transformed image or fusion on the two images in the same image pair to acquire a fused image; and
evaluating, for the transformed image or the fused image, the stitching result of the same image pair by utilizing at least one selected from a group of results of target detection, feature extraction, shape detection, structural similarity, and peak signal-to-noise ratio to determine whether the stitching result of the same image pair meets the predetermined condition.

7. The method according to claim 1, wherein,
the further stitching, in response to the plurality of images being inclusive of the plurality of image rows, the plurality of images by image columns along the second direction so as to generate the stitched image includes:
acquiring, in an image pair-by-image pair stitching process performed on the plurality of images by image columns along the second direction, a second stitching homography matrix corresponding to each of image pairs formed by the adjacent images, wherein, a stitching result of the same image pair is evaluated based on the second stitching homography matrix corresponding to the same image pair, and in response to the stitching result of the same image pair not meeting a predetermined condition, the same image pair is stitched by utilizing the second stitching homography matrix corresponding to the image pair of the same image row in a previously-stitched image column, or a second initial homography matrix corresponding to the image row, where the same image pair is located, is acquired and utilized to stitch the same image pair.

8. An apparatus for stitching images, comprising:
a processor; and
a storage storing a computer program, coupled to the processor,
wherein, the computer program causes, when executed by the processor, the processor to implement
obtaining a plurality of images arranged in an array, wherein, the array of the plurality of images contains a plurality of image columns along a first direction and at least one image row along a second direction different from the first direction, and there is at least a predetermined range of overlap greater than zero between the adjacent images respectively arranged along the first direction and the second direction;
acquiring, in an image pair-by-image pair stitching process performed on the plurality of images by image rows along the first direction, a first stitching homography matrix corresponding to each of image pairs formed by the adjacent images, wherein, a stitching result of the same image pair is evaluated based on the first stitching homography matrix corresponding to the same image pair, and in response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is acquired and utilized to stitch the same image pair; and
further stitching, in response to the plurality of images being inclusive of a plurality of image rows, the plurality of images by image columns along the second direction so as to generate a stitched image.

9. The apparatus according to claim 8, wherein,
the acquisition of the first initial homography matrix corresponding to the image column, where the same image pair is located, includes
acquiring, based on a relative displacement between the images in the same image pair, the first initial homography matrix corresponding to the image column where the same image pair is located, wherein, the first initial homography matrix represents the relative displacement.

10. The apparatus according to claim 8, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of a plurality of image rows and there being one or more previously-stitched image rows, selecting the first stitching homography matrix corresponding to the image pair of the same image column in a first previously-stitched image row closest to the image row where the same image pair is located, further evaluating the stitching result of the same image pair, and stitching the same image pair in response to the evaluated stitching result meeting the predetermined condition,
in response to the further evaluated stitching result not meeting the predetermined condition, sequentially choosing the first stitching homography matrix corresponding to the image pair of the same image column in a second previously-stitched image row closest to the first previously-stitched image row, and stitching the same image pair in response to the evaluated stitching result meeting the predetermined condition, and
in response to the evaluated stitching results based on the first stitching homography matrices of all the previously-stitched image rows not meeting the predetermined condition, selecting the first initial homography matrix corresponding to the image column, where the same image pair is located, to stitch the same image pair.

11. The apparatus according to claim 8, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of one image row or there not being one or more previously-stitched image rows, selecting the first initial homography matrix corresponding to the image column, where the same image pair is located, to stitch the same image pair.

12. The apparatus according to claim 8, wherein,
the evaluation of the stitching result of the same image pair based on the first stitching homography matrix corresponding to the same image pair includes
performing, based on the first stitching homography matrix corresponding to the same image pair, transform on an image in the same image pair to acquire a transformed image or fusion on the two images in the same image pair to acquire a fused image; and
evaluating, for the transformed image or the fused image, the stitching result of the same image pair by utilizing at least one selected from a group of results of target detection, feature extraction, shape detection, structural similarity, and peak signal-to-noise ratio to determine whether the stitching result of the same image pair meets the predetermined condition.

13. The apparatus according to claim 8, wherein,
the further stitching, in response to the plurality of images being inclusive of the plurality of image rows, the plurality of images by image columns along the second direction so as to generate the stitched image includes:
acquiring, in an image pair-by-image pair stitching process performed on the plurality of images by image columns along the second direction, a second stitching homography matrix corresponding to each of image pairs formed by the adjacent images, wherein, a stitching result of the same image pair is evaluated based on the second stitching homography matrix corresponding to the same image pair, and in response to the stitching result of the same image pair not meeting a predetermined condition, the same image pair is stitched by utilizing the second stitching homography matrix corresponding to the image pair of the same image row in a previously-stitched image column, or a second initial homography matrix corresponding to the image row, where the same image pair is located, is acquired and utilized to stitch the same image pair.

14. A non-transitory computer-readable medium having a computer program for execution by a processor, wherein,
the computer program causes, when executed by the processor, the processor to implement
obtaining a plurality of images arranged in an array, wherein, the array of the plurality of images contains a plurality of image columns along a first direction and at least one image row along a second direction different from the first direction, and there is at least a predetermined range of overlap greater than zero between the adjacent images respectively arranged along the first direction and the second direction;
acquiring, in an image pair-by-image pair stitching process performed on the plurality of images by image rows along the first direction, a first stitching homography matrix corresponding to each of image pairs formed by the adjacent images, wherein, a stitching result of the same image pair is evaluated based on the first stitching homography matrix corresponding to the same image pair, and in response to the stitching result of the same image pair not meeting a predetermined condition, the same image pair is stitched by utilizing the first stitching homography matrix corresponding to the image pair of the same image column in a previously-stitched image row, or a first initial homography matrix corresponding to the image column, where the same image pair is located, is acquired and utilized to stitch the same image pair; and
further stitching, in response to the plurality of images being inclusive of a plurality of image rows, the plurality of images by image columns along the second direction so as to generate a stitched image.

15. The non-transitory computer-readable medium according to claim 14, wherein,
the acquisition of the first initial homography matrix corresponding to the image column, where the same image pair is located, includes
acquiring, based on a relative displacement between the images in the same image pair, the first initial homography matrix corresponding to the image column where the same image pair is located, wherein, the first initial homography matrix represents the relative displacement.

16. The non-transitory computer-readable medium according to claim 14, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of a plurality of image rows and there being one or more previously-stitched image rows, selecting the first stitching homography matrix corresponding to the image pair of the same image column in a first previously-stitched image row closest to the image row where the same image pair is located, further evaluating the stitching result of the same image pair, and stitching the same image pair in response to the evaluated stitching result meeting the predetermined condition,
in response to the further evaluated stitching result not meeting the predetermined condition, sequentially choosing the first stitching homography matrix corresponding to the image pair of the same image column in a second previously-stitched image row closest to the first previously-stitched image row, and stitching the same image pair in response to the evaluated stitching result meeting the predetermined condition, and
in response to the evaluated stitching results based on the first stitching homography matrices of all the previously-stitched image rows not meeting the predetermined condition, selecting the first initial homography matrix corresponding to the image column, where the same image pair is located, to stitch the same image pair.

17. The non-transitory computer-readable medium according to claim 14, wherein,
in response to the stitching result of the same image pair not meeting the predetermined condition, the utilizing the first stitching homography matrix corresponding to the image pair of the same image column in the previously-stitched image row to stitch the same image pair, or acquiring the first initial homography matrix corresponding to the image column, where the same image pair is located, and utilizing the first initial homography matrix to stitch the same image pair includes
in response to the plurality of images being inclusive of one image row or there not being one or more previously-stitched image rows, selecting the first initial homography matrix corresponding to the image column, where the same image pair is located, to stitch the same image pair.

18. The non-transitory computer-readable medium according to claim 14, wherein,
the evaluation of the stitching result of the same image pair based on the first stitching homography matrix corresponding to the same image pair includes
performing, based on the first stitching homography matrix corresponding to the same image pair, transform on an image in the same image pair to acquire a transformed image or fusion on the two images in the same image pair to acquire a fused image; and
evaluating, for the transformed image or the fused image, the stitching result of the same image pair by utilizing at least one selected from a group of results of target detection, feature extraction, shape detection, structural similarity, and peak signal-to-noise ratio to determine whether the stitching result of the same image pair meets the predetermined condition.

19. The non-transitory computer-readable medium according to claim 14, wherein,
the further stitching, in response to the plurality of images being inclusive of the plurality of image rows, the plurality of images by image columns along the second direction so as to generate the stitched image includes:
acquiring, in an image pair-by-image pair stitching process performed on the plurality of images by image columns along the second direction, a second stitching homography matrix corresponding to each of image pairs formed by the adjacent images, wherein, a stitching result of the same image pair is evaluated based on the second stitching homography matrix corresponding to the same image pair, and in response to the stitching result of the same image pair not meeting a predetermined condition, the same image pair is stitched by utilizing the second stitching homography matrix corresponding to the image pair of the same image row in a previously-stitched image column, or a second initial homography matrix corresponding to the image row, where the same image pair is located, is acquired and utilized to stitch the same image pair.
